(19) United States
(12) Patent Application Publication
(10) Pub. No.: US 2015/0185022 A1
(43) Pub. Date: Jul. 2, 2015

(54) STEREOSCOPIC INDOOR ROUTE PROVIDING APPARATUS, SYSTEM AND METHOD

(71) Applicant: Electronics and Telecommunications Research Institute, Daejeon (KR)

(72) Inventors: Jae Jun YOO, Daejeon (KR); So Yeon LEE, Daejeon (KR); Sang Joon PARK, Daejeon (KR); Jong Hyun PARK, Daejeon (KR)

(21) Appl. No.: 14/316,741

(22) Filed: Jun. 26, 2014

(30) Foreign Application Priority Data
Dec. 27, 2013 (KR) 10-2013-0165383

(51) Int. Cl. G01C 21/20; H04W 4/04; H04W 64/00

(52) U.S. Cl. CPC G01C 21/206; H04W 64/00; H04W 4/04

(57) ABSTRACT

Provided are an apparatus, system, and method for providing a stereoscopic indoor route, which can effectively guide a route in consideration of various features and structures of the indoor space unlike an existing navigation performed on only the outdoor space, in order to provide a navigation service performed on the indoor space. For stereoscopic movement, such as going upstairs or downstairs in inter-floor movement, which is characteristic of the indoor space, it is also possible to effectively and efficiently provide route guidance to a user by indicating up and down directions with a special arrow or icon and visualizing a route with icons for facilities, such as a general door, a revolving door, an escalator, and an elevator, which are specialized in the indoor space.

### CROSS-REFERENCE TO RELATED APPLICATIONS

This application claims priority under 35 U.S.C. §119 to Korean

Patent Application No. 10-2013-0165383, filed on Dec. 27, 2013, the disclosure of which is incorporated herein by reference in its entirety.

### TECHNICAL FIELD

The present invention relates to an indoor route providing apparatus and method that can provide a route guidance service with respect to an indoor space, and more particularly, to a method of stereoscopically visualizing a route searched by a navigation service for an indoor space to provide the visualized route to a user.

### BACKGROUND

Route guidance, which has been widely used at present, of a navigation service with respect to an outdoor space is provided by displaying a route on roads of an existing outdoor map. When a vehicle terminal having the existing navigation service installed therein moves according to the route, the guided route is updated according the changed location information and then output on the outdoor map.

In most of the existing navigation systems, the roads are visualized based on two dimensions (2D), such that the existing route guidance may be mostly provided in 2D. Navigation services have been introduced which can visualize more real environment by providing the surrounding environment in 3D and representing geographical height variation such as a descent and an ascent. However, the services are the same as the related art in that both perform route guidance on an existing road system having a planar connection structure and thus represent a 2D based route.

However, technologies and services have been developed such that a navigation device desiring to guide a route up to a specific destination may have a target region including a large indoor space, such as a convention center, in addition an existing outdoor space. Thus it is needed to perform an efficient search for a route in consideration of the features of the indoor space.

Since an indoor space has a stereoscopic structure based on several floors unlike an outdoor space where roads are connected on a plane, the route search for the indoor space should easily provide a user with inter-floor movement between an upper floor and a lower floor and movement through indoor facilities such as an elevator, escalator, or the like.

### SUMMARY

Accordingly, the present invention provides an apparatus and method for providing a stereoscopic indoor route, which can efficiently provide (visualize) a result of the route search in consideration of various features and structures of an indoor space when a navigation is performed on the indoor space in addition to on an outdoor space.

In one general aspect, an apparatus for providing a stereoscopic indoor route, the apparatus including: a terminal location acquisition unit configured to acquire current location information of a terminal; a database unit configured to store indoor route information; a 3D indoor route search unit configured to, when a route search instruction is received, search for an indoor route up to a destination based on the current location information of the terminal and the indoor route information and, when inter-floor movement route is included in the route information, generate additional information about the inter-floor movement route, a display unit configured to provide the indoor route up to the destination and the additional information about the inter-floor movement route; and a service providing unit configured to provide a route guidance service according to the indoor route up to the destination searched by the 3D indoor route search unit.

The 3D indoor route search unit may generate n the indoor route providing server may generate additional information including at least one of a departure floor, an arrival floor, a movement direction, and a movement means of the inter-floor movement route in a form of an icon including at least one of a character, an arrow, and an image.

When searching for an indoor route with a shortest time it takes to go to the destination, the 3D indoor route search unit may search for the indoor route up to the destination by using an average movement speed of a movement means for the inter-floor movement route.

The 3D indoor route search unit may check whether the inter-floor movement route is included in the indoor route by checking route information included in the indoor route up to the destination.

When there is a structure on the indoor route to the destination, the 3D indoor route search unit apparatus may provide information about the structure.

The database unit may store an identifier of the route information, information whether the route information includes inter-floor movement route, and information about a departure floor, an arrival floor, and a movement means of the inter-floor movement route.

The display unit may display the additional information about the inter-floor movement route when the current location information is within a certain distance from the inter-floor movement route.

When a selection instruction for the inter-floor movement route is received, the display unit may display an indoor route from the arrival floor of the inter-floor movement route to the destination.

In another general aspect, a method for providing a stereoscopic indoor route, the method including: receiving a destination and searching for an indoor route from a current location to the destination; when inter-floor movement route is included in the indoor route, generating additional information about the inter-floor movement route; providing the indoor route up to the destination and the additional information about the inter-floor movement route; and providing a route guidance service according to the indoor route up to the destination and the inter-floor movement route.

In still another general aspect, a system for providing a stereoscopic indoor route, the system including: a user terminal configured to transmit current location information and destination information, and when an indoor route up to the destination is received, output the indoor route to a screen; and an indoor route providing server configured to, when the current location information and the destination information are received from the user terminal, search for the indoor route up to the destination, and when inter-floor movement route is included in the indoor route, generate additional information about the inter-floor movement route, and transmit the indoor route up to the destination and the additional information about the inter-floor movement route to the user terminal

Other features and aspects will be apparent from the following detailed description, the drawings, and the claims.

### BRIEF DESCRIPTION OF THE DRAWINGS

FIG. 1 is a block diagram showing an apparatus for providing a stereoscopic indoor route according to an embodiment of the present invention.

FIG. 2 is a flowchart showing a method of providing a stereoscopic indoor according to an embodiment of the present invention.

FIG. 3 is an exemplary diagram of a structure of indoor route information stored in an apparatus for providing the stereoscopic indoor route according to an embodiment of the present invention.

FIGS. 4A and 4B are exemplary diagrams of an indoor route guidance according to an existing navigation system.

FIGS. 4C and 4D are exemplary diagrams of an indoor route guidance screen provided by an apparatus for providing the stereoscopic indoor route according to an embodiment of the present invention.

FIGS. 5A and 5B are exemplary diagrams of an indoor route guidance according to an existing navigation system.

FIG. 5C is an exemplary diagram of an indoor route guidance screen provided by an apparatus for providing the stereoscopic indoor route according to an embodiment of the present invention.

FIG. 6A is an exemplary diagram of an indoor route guidance according to an existing navigation system.

FIG. 6B is an exemplary diagram of an indoor route guidance screen provided by an apparatus for providing the stereoscopic indoor route according to an embodiment of the present invention.

FIG. 7 is an exemplary diagram of icons representing the information about an indoor route guidance according to an embodiment of the present invention.

FIG. 8 is a block diagram showing a computer system implemented according to an embodiment of the present invention.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

A method of guiding and visualizing a stereoscopic route based on an icon in indoor space navigation, which is one of subject matters of the present invention, includes providing and visualizing information about a route by utilizing icons for up and down movement (upstairs and downstairs) and a variety of indoor space structures (facility), such as a revolving door, an escalator, and an elevator, which are specialized in the indoor space

The present invention will be described in detail below with reference to several views.

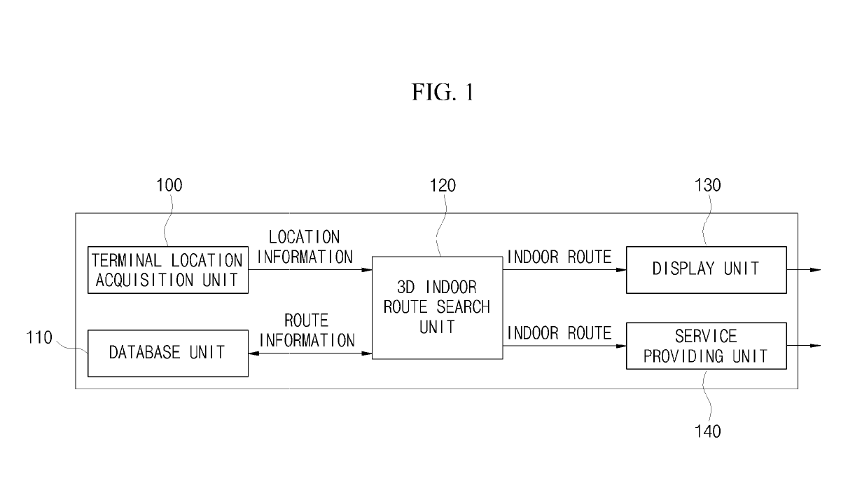

FIG. 1 is a block diagram showing a configuration of an apparatus for providing a stereoscopic indoor route according to an embodiment of the present invention.

The apparatus for providing a stereoscopic indoor route according to an embodiment of the present invention includes a terminal location acquisition unit 100, a database unit 110, a 3D indoor route search unit 120, a display unit 130, and a service provision unit 140.

The terminal location acquisition unit 100 acquires a current location of a terminal and delivers the acquired current location to the 3D indoor route search unit 120.

The database unit 110 stores data needed for indoor navigation, such as 3D indoor route information and an indoor map. The database unit 110 may perform communication with a server to check whether route information about an indoor space where the terminal is currently located is updated, on the basis of the current position information acquired by the terminal position acquisition unit 100. If the route information is updated, the database unit 110 may receive the updated route information from the server and store the received route information therein.

When a route search instruction is input, the 3D indoor route search unit 120 searches for an indoor route from the current position of the terminal, which is delivered from the terminal position acquisition unit 100, to a destination on the basis of the indoor route information stored in the database unit 110.

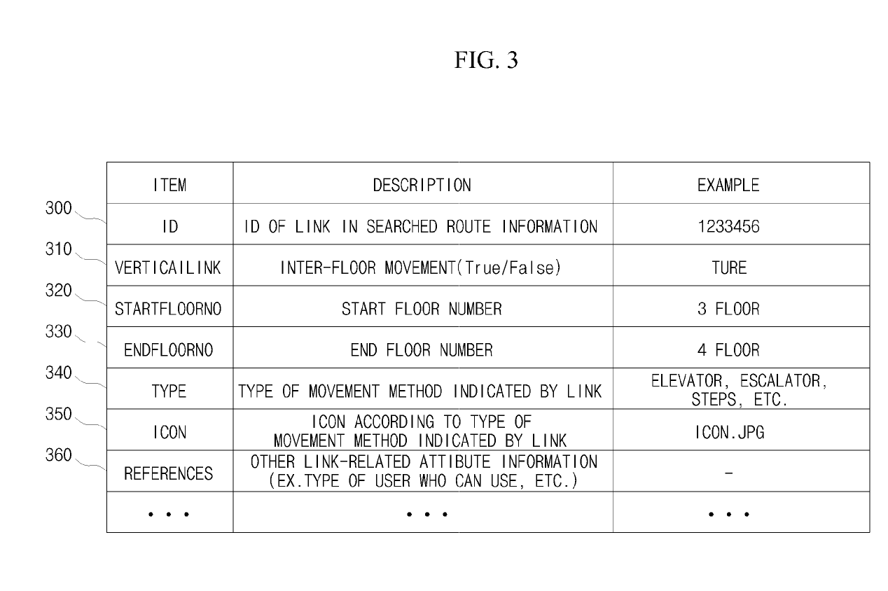

The 3D indoor route search unit 120 searches for an indoor route to check whether the indoor route includes an inter-floor movement route. Whether the indoor route includes an inter-floor movement route may be checked on the basis of whether the indoor route information stored in the database unit 110 is the inter-floor movement route. The indoor route information may be configured as shown in FIG. 3.

FIG. 3 illustrates an example of a configuration of attribute information which is referenced and utilized in association with each link (or a movement route between nodes) in network route information, which is generally indicated as a node link in order to indicate stereoscopic route guidance in the indoor space.

For the above-described stereoscopic route guide in the indoor space, it is necessary to search for route information about a specific destination and also information about which movement route of a building corresponds to the route information. The information may be stored and managed with respect to a start node and an end node of a specific link and also stored and managed with respect to the specific node. FIG. 3 illustrates an example of the attribute information that may be maintained and managed with respect to each link when the information is stored and managed with respect to the specific node.

Among the attribute information of FIG. 3, ID 300 of the attribute information means a unique identifier of the link, and VerticalLink 310 means whether the link indicates a movement route between floors or a movement route in one single floor. If the link indicates a movement route between floors (in a case of “True”), information about a start floor and information about an end floor are indicated by StartFloorNo 320 and EndFloorNo 330, respectively.

Type 340 indicates a type of facility (e.g., an escalator, an elevator, and stairs) which the movement is based on, and Icon 350 means, when there is an icon indicating Type 340, reference information (e.g., a pointer for an image) about the icon. Various attribute information may be additionally defined and referenced to support various service scenarios, route display methods, and display information, which may be designated by References 360.

The 3D indoor route search unit 120 generates additional information about the inter-floor movement route when the inter-floor movement route is included in the indoor route up to the destination. The additional information about the inter-floor movement rout is used to visualize and provide information about the inter-floor movement route to a user, and configured to include at least one of a departure floor, an arrival floor, a movement means, and a movement direction of the inter-floor movement route.

The addition information about the inter-floor movement route may be provided in the form of an icon to allow a user to easily find out the information about the inter-floor movement route.

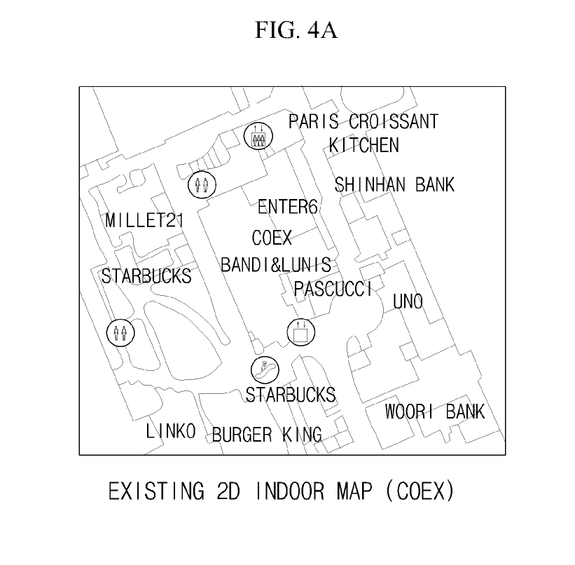

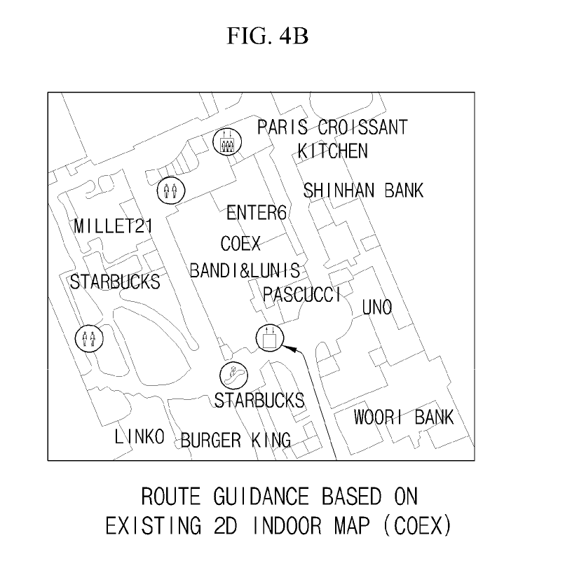

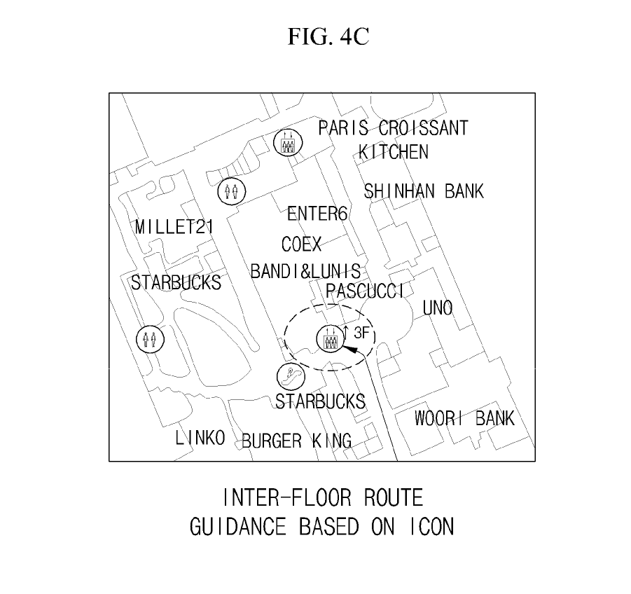

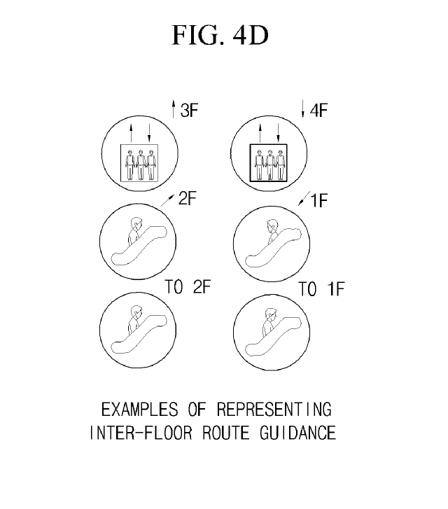

FIGS. 4A to 4D, 5A to 5C, 6A, 6B and 7 illustrate an example of providing the additional information about the inter-floor movement route.

FIGS. 4A to 4D illustrate an example of navigation route guidance considering features (a structure of floors, a stereoscopic structure and facility, etc.) of an indoor space.

More specifically, FIG. 4A illustrates an example of a 2D based indoor map (for example, South Korean convention and exhibition centre (COEX)), and FIG. 4B illustrates an example of route guidance in an existing method based on the FIG. 4A. However, since route search and guidance provided by indoor navigation should allow inter-floor movement according to a current location of a user and a location of a target destination, it is necessary to display the inter-floor movement on a route. However, the existing navigation service and system cannot display such information because the navigation service and system considers only a planar structure based on an outdoor space.

FIG. 4C expands FIG. 4B, and illustrates one of route guidance methods including various features of the indoor space according to the present invention and an embodiment of displaying the route information including inter-floor movement.

FIG. 4D shows in detail the method of FIG. 4C, and two icons on a top line indicate movement using an elevator. Specifically, a left icon indicates information about going up to the three floor, and a right icon indicates information about going down to information go down to the third basement. A left icon of a middle line indicates information about riding an escalator to go up to the second floor, by specifying an arrow and a floor in addition to the icon of an escalator, and a right icon thereof indicates information about riding an escalator to go down to the first floor. Two icons of a bottom line indicate floors intended to move by riding an escalator, using Hangul (Korean alphabet).

As described above, FIG. 4D may be one embodiment that can efficiently display a route up to a destination without a semantic error even in the indoor space by displaying route guidance for the inter-floor movement in the indoor space having several floors in addition to an icon of an existing facility, a direction to the destination, and a target floor and visualizing the information in addition to the existing route information.

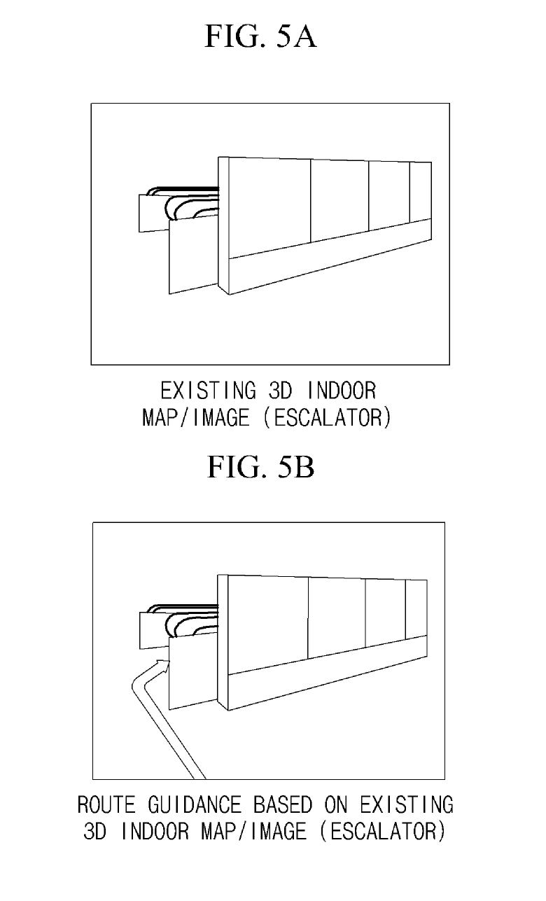

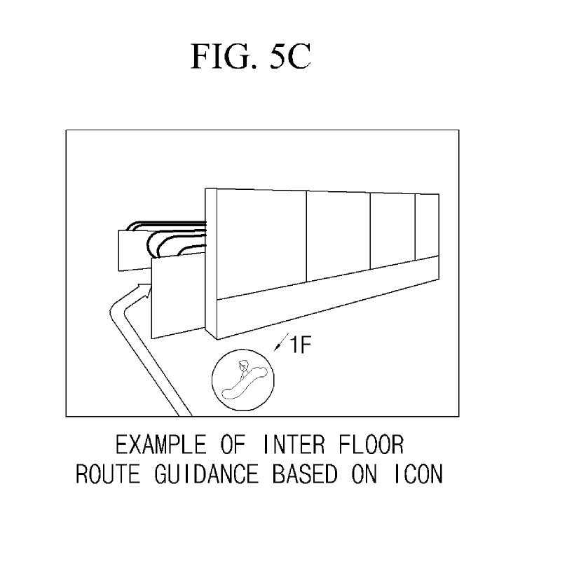

While FIGS. 4A to 4D illustrate embodiments of the route guidance displayed in addition to the inter-floor information in a 2D indoor map, FIGS. 5A to 5C illustrate an embodiment of a method of guiding an inter-floor movement route in an indoor space navigation based on a 3D indoor map and an indoor image (augmented reality).

FIG. 5A illustrates an example (escalator) of an image for a specific indoor space, and FIG. 5B illustrates an example of a route guidance method provided by the existing navigation.

However, the route guidance cannot provide a user to information about which floor the user should go down to. FIG. 5C illustrates one of solutions proposed by the present invention, which may allow the inter-floor movement in the indoor space to be more clearly guided by displaying a target floor, a direction (up or down), and an icon for an available indoor facility (structure) in addition to the existing route display method as shown in FIG. 5B.

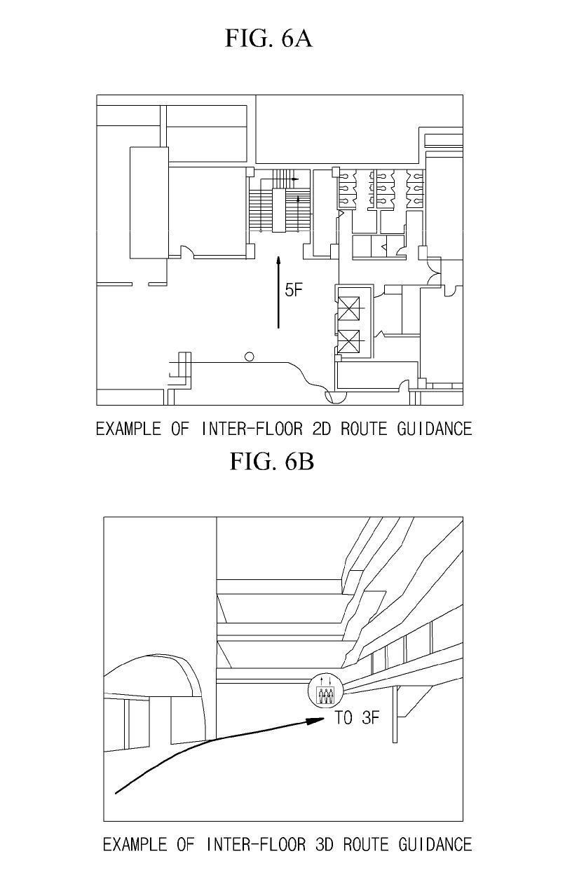

FIGS. 6A and 6B illustrate a similar embodiment, which is an embodiment about a case where the inter-floor movement is two-dimensionally guided (FIG. 6A) and a case where the inter-floor movement is three-dimensionally guided based on an indoor image (FIG. 6B).

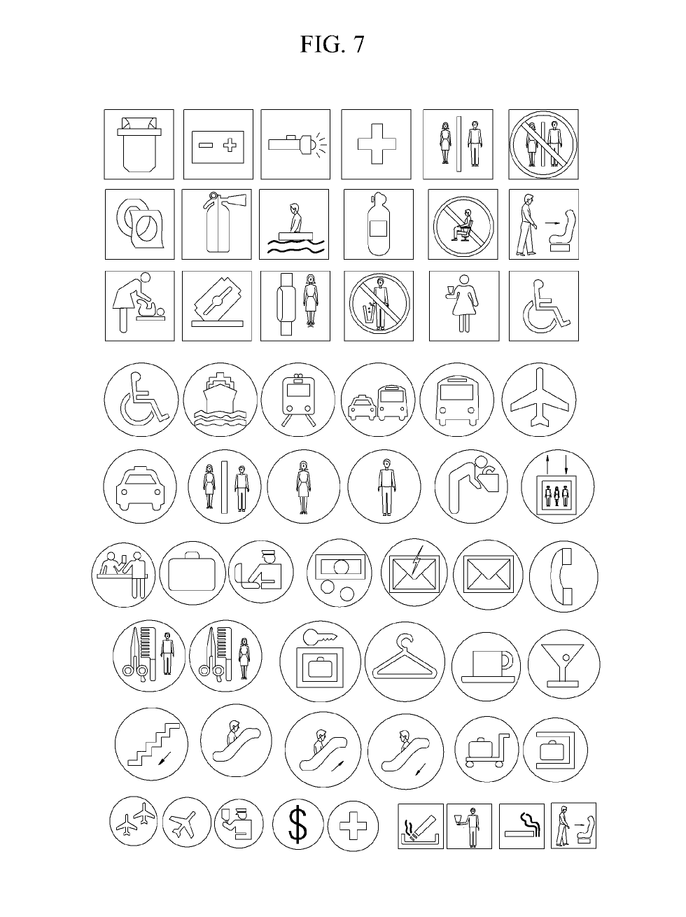

The method for guiding a stereoscopic route (inter-floor movement, etc.) in an indoor space described with reference to FIGS. 4C, 4D, 5C and 6B includes iconizing direction information about the inter-floor movement, a target floor, and information about a facility (structure) for movement to provide the iconized information in addition to an existing movement route displaying method, thereby iconizing and efficiently and readably providing various information. The method for guiding a stereoscopic route (inter-floor movement, etc.) in an indoor space is not provided by the existing outdoor navigation for the outdoor space and should be necessarily supported such that the existing outdoor space navigation may provide route search with respect to the indoor space. And FIG. 7 illustrates an example of icons representing the information about the indoor route guidance.

The 3D indoor search unit 120 provides the additional information about an indoor route up to a searched destination and an inter-floor movement route through the display unit 130. The service providing unit 140 provides a route guidance service to a user on the basis of a current location of a terminal and an indoor route provided through the display unit 130.

According to another embodiment of the present invention, the display unit 130 may display the additional information about the inter-floor movement route when the terminal is located within a certain distance from the inter-floor movement route and may display an indoor route (that is, information about an indoor route after moving to another floor) from a destination floor of the inter-floor route when the user selects the additional information about the inter-floor movement route.

The above-described configuration can be changed to a configuration in which central management server provides functions corresponding to the database unit 110 for storing an indoor map and 3D indoor route information and the 3D indoor route search unit 120 according to a configuration and features of the indoor navigation service. In this case, the terminal delivers search conditions to a service server, receives search results, and visualizes the received search results on a screen.

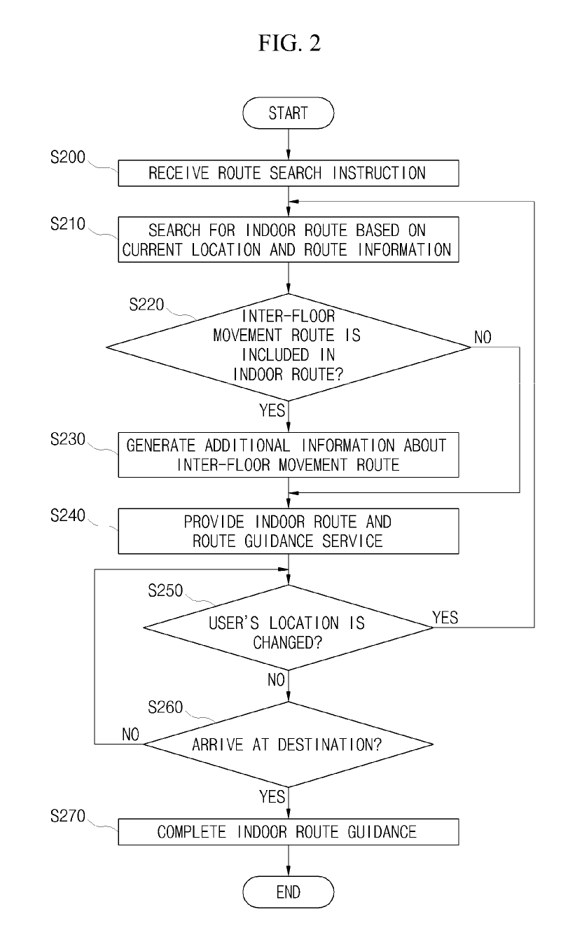

FIG. 2 is a flowchart showing a method of providing a stereoscopic indoor according to an embodiment of the present invention.

An apparatus for providing a stereoscopic indoor route receives a route search condition (e.g., a destination, route search criteria such as a shortest distance and a shortest time, etc.) and a route search instruction in operation S200 and searches for the indoor route on the basis of the current location and the route information in operation S210. When the route search is performed based on a shortest time, the apparatus may calculate the shortest time and then perform the route search using an average moving speed of a movement means of the inter-floor movement route included in the indoor route.

The apparatus searches for an indoor route and checks whether the inter-floor movement route is included in the indoor route in operation S220. The apparatus generates additional information about the inter-floor movement route when the inter-floor movement route is included in the indoor route in operation S230. The additional information about the inter-floor route may include at least one of a departure floor, an arrival floor, a movement means, and a moving direction of the inter-floor movement route and may be generated as an icon including a character, an arrow, an image, and so on.

The apparatus provides the generated indoor route and the generated additional information about the inter-floor movement route through a screen and provides a service for route guidance to a destination in operation S240.

When a service for the indoor navigation is visualized to a user, the apparatus may check whether the user moves such that a current location of the user is changed in operation S250 and search for a route and relevant addition information again. When a user arrives at a destination according to guidance provided by the indoor navigation service in operation S260, the indoor navigation service is completed in operation S270.

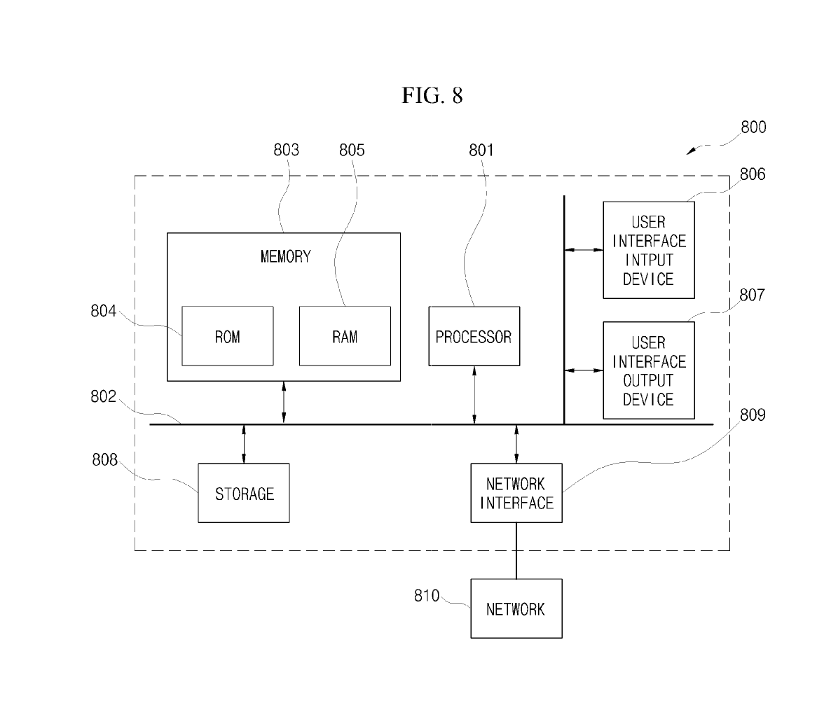

An embodiment of the present invention may be implemented in a computer system, e.g., as a computer readable medium. As shown in FIG. 8, a computer system 800 may include one or more of a processor 801, a memory 803, a user input device 806, a user output device 807, and a storage 808, each of which communicates through a bus 802. The computer system 800 may also include a network interface 809 that is coupled to a network 810. The processor 801 may be a central processing unit(CPU) or a semiconductor device that executes processing instructions stored in the memory 803 and/or the storage 808. The memory 803 and the storage 808 may include various forms of volatile or non-volatile storage media. For example, the memory 803 may include a read-only memory(ROM) 804 and a random access memory(RAM) 805.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

According to the present invention, in order to provide a navigation service performed on the indoor space, unlike an existing navigation performed on only the outdoor space, it is possible to effectively guide a route in consideration of various features (e.g., a layered structure) and structures (e.g., a facility) of the indoor space.

For stereoscopic movement, such as going upstairs or downstairs in inter-floor movement, which is characteristic of the indoor space, it is also possible to effectively and efficiently provide route guidance to a user by indicating up and down directions with a special arrow or icon and visualizing a route with icons for facilities (structures), such as a general door, a revolving door, an escalator, and an elevator, which are specialized in the indoor space.

The above-described subject matter of the present invention is to be considered illustrative and not restrictive, and it should be understood that numerous other modifications and embodiments can be devised by those skilled in the art that will fall within the spirit and scope of the principles of the present invention. Accordingly, the embodiments of the present invention are to be considered descriptive and not restrictive of the present invention, and do not limit the scope of the present invention. The scope of the present invention should be determined by the following claims and their appropriate legal equivalents.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing a stereoscopic indoor route, the apparatus comprising:
a terminal location acquisition unit configured to acquire current location information of a terminal;
a database unit configured to store indoor route information;
a 3D indoor route search unit configured to, when a route search instruction is received, search for an indoor route up to a destination based on the current location information of the terminal and the indoor route information and when inter-floor movement route is included in the indoor route, generate additional information about the inter-floor movement route; and
a display unit configured to provide the indoor route up to the destination and the additional information about the inter-floor movement route.

2. The apparatus of claim 1, wherein the 3D indoor route search unit generates additional information including at least one of a departure floor, an arrival floor, a movement direction, and a movement means of the inter-floor movement route.

3. The apparatus of claim 1, wherein the 3D indoor route search unit generates the additional information about the inter-floor movement route in a form of an icon including at least one of a character, an arrow, and an image.

4. The apparatus of claim 1, wherein when searching for an indoor route with a shortest time it takes to go to the destination, the 3D indoor route search unit searches for the indoor route up to the destination by using an average movement speed of a movement means for the inter-floor movement route.

5. The apparatus of claim 1, wherein the 3D indoor route search unit checks whether the inter-floor movement route is included in the indoor route by checking route information included in the indoor route up to the destination.

6. The apparatus of claim 1, wherein when there is a structure on the indoor route up to the destination, the 3D indoor route search unit provides information about the structure.

7. The apparatus of claim 1, wherein the database unit stores an identifier of the route information, information whether the route information includes inter-floor movement route, and information about a departure floor, an arrival floor, and a movement means of the inter-floor movement route.

8. The apparatus of claim 1, wherein the display unit displays the additional information about the inter-floor movement route when the current location information is within a certain distance from the inter-floor movement route.

9. The apparatus of claim 1, wherein when a selection instruction for the inter-floor movement route is received, the display unit displays an indoor route from the arrival floor of the inter-floor movement route up to the destination.

10. The apparatus of claim 1, further comprising a service providing unit configured to provide a route guidance service according to the indoor route up to the destination searched by the 3D indoor route search unit.

11. A method for providing a stereoscopic indoor route, the method comprising:
receiving a destination and searching for an indoor route from a current location to the destination;
when inter-floor movement route is included in the indoor route, generating additional information about the inter-floor movement route ; and
providing the indoor route up to the destination and the additional information about the inter-floor movement route.

12. The method of claim 11, wherein the generating of additional information about the inter-floor movement route comprises generating additional information including at least one of a departure floor, an arrival floor, a movement direction, and a movement means of the inter-floor movement route.

13. The method of claim 11, wherein the providing of the indoor route up to the destination and the additional information about the inter-floor movement route comprises providing the additional information about the inter-floor movement route in a form of an icon including at least one of a character, an arrow, and an image.

14. The method of claim 11, wherein the providing of the indoor route up to the destination and the additional information about the inter-floor movement route comprises providing the additional information about the inter-floor movement route when the current location is within a certain distance from the inter-floor movement route.

15. The method of claim 11, further comprising providing a route guidance service according to the indoor route up to the destination and the inter-floor movement route.

16. A system for providing a stereoscopic indoor route, the system comprising:
a user terminal configured to transmit current location information and destination information, and when an indoor route up to the destination is received, output the indoor route to a screen; and
an indoor route providing server configured to, when the current location information and the destination information are received from the user terminal, search for the indoor route up to the destination, and when inter-floor movement route is included in the indoor route, generate additional information about the inter-floor movement route, and transmit the indoor route up to the destination and the additional information about the inter-floor movement route to the user terminal

17. The system of claim 16, wherein the indoor route providing server generates additional information including at least one of a departure floor, an arrival floor, a movement direction, and a movement means of the inter-floor movement route in a form of an icon including at least one of a character, an arrow, and an image.

18. The system of claim 16, wherein the indoor route providing server receives the current location information of the user terminal at certain intervals, and when the current location information of the user is not included in the indoor route up to the destination, generates a new indoor route up to the destination to transmit the new indoor route to the user terminal

19. The system of claim 16, wherein the user terminal provides the indoor route up to the destination and the additional information about the inter-floor movement route in three dimensions.

20. The system of claim 16, wherein the user terminal provides a route guidance service according to the indoor route up to the destination and the additional information about the inter-floor movement route.
